(19) United States
(12) Patent Application Publication
(10) Pub. No.: US 2005/0015575 A1
(43) Pub. Date: Jan. 20, 2005

(54) Processor and method capable of automatically converting instruction mode to align word boundary of a multi-mode instruction set

(75) Inventor: June-Yuh WU, Renwu Township (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/747,117

(22) Filed: Dec. 30, 2003

(30) Foreign Application Priority Data
Jul. 16, 2003 (TW) 092119391

(51) Int. Cl. G06F 9/30

(52) U.S. Cl. 712/209; 712/227

(57) ABSTRACT

A processor and method capable of automatically converting instruction mode to align a word boundary of a multi-mode instruction is disclosed, wherein the multi-mode instruction to be executed is from an L-bit instruction word. The L-bit instruction word contains an M-bit instruction or a plurality of N-bit instructions. When the L-bit word fetched is an M-bit instruction and its preceding L-bit word is an N-bit instruction, an N-bit instruction is converted into corresponding M-bit instruction when the N-bit instruction corresponds to an M-bit instruction, otherwise, at least one N-bit NOP instruction following the N-bit instruction is inserted.

### BACKGROUND OF THE INVENTION

1. Field of the Invention

The present invention relates to the technical field of processor and, more particularly, to a processor and method capable of automatically converting instruction mode switch to align word boundary of a multi-mode instruction set.

2. Description of Related Art

Typically, a processor is provided with 32-bit/16-bit instruction modes and capable of switching between the two modes to save required memory for storing programming codes. U.S. Pat. No. 5,758,115 granted to Nevill and Edward Colles for an “Interoperability with multiple instruction sets” uses T bits of a program counter (PC) to determine whether the processor has 32-bit or 16-bit instruction mode and uses an branch instruction to change values of the T bits. The instruction modes are switched as shown in FIG. 1. When the branch instruction 220 is performed to branch a program flow to a start address Badd(1) that is stored with a 16-bit instruction so as to execute the 16-bit instruction. The T bits is switched by +1 to inform the processor to be in the 16-bit instruction mode. The branch instruction 240 is performed to branch the program flow to address Badd(2) that is stored with a 32-bit instruction to execute the 32-bit instruction. Such an instruction mode switch is employed by processors of ARM and MIPS series. However, such a procedure requires different memory blocks to separately store 32-bit and 16-bit instructions, other than the same memory block to integrally store the instructions. Therefore, programming code storage cannot be optimized. That is, such a switching method lacks of code storage optimization, as well as it requires additional storage for further mode switching.

As to the aforementioned problem, U.S. Pat. No. 6,209,079B1 granted to Otani, et al. for a “Processor for executing instruction codes of two different lengths and device for inputting the instruction codes” has provided a solution by applying the most significant bit (MSB) of an instruction code to determine whether the processor is in 32-bit or 16-bit instruction mode. As shown in FIG. 2, the 32-bit is a 32-bit instruction if the MSB on 32-bit boundary is ‘1’ and two 16-bit instructions if the MSB on 32-bit boundary is ‘0’. Two 16-bit instructions are performed sequentially if the MSB of 16-bit instruction B is ‘1’. Two 16-bit instructions are performed in parallel if the MSB of 16-bit instruction B is ‘0’. Such an instruction mode switch is used in the processors of M32R series. In this case, the 32-bit and 16-bit instructions can be stored in the same block to increase code density. However, when a branch or jump instruction is performed, it needs to be dealt careful to avoid jumping to the last half portion of a 32-bit instruction. Because the last half portion is not executable, it may cause unpredictable error. Therefore, the jump address requires to be limited to word boundary or 32-bit boundary. Return addresses for branch-and-link and jump-and-link instructions also require to be limited to a word boundary or 32-bit boundary. Such a limitation adds inconvenience in use. Therefore, the conventional 32-bit/16-bit instruction mode change still encounters many problems, and thus it is desirable to provide an improved processor and method to mitigate and/or obviate the aforementioned problems.

### SUMMARY OF THE INVENTION

The object of the present invention is to provide a processor and method capable of automatically converting instruction mode to align a word boundary of a multi-mode instruction, thereby avoiding complicated problem presented on the word boundary or 32-bit boundary caused by the prior jump address limitation, and increasing performance speed of the processor.

According to a feature of the present invention, there is provided a processor capable of automatically converting instruction mode to align a word boundary of a multi-mode instruction, wherein a multi-mode instruction to be executed is come from an L-bit instruction boundary. The L-bit instruction word can contain an M-bit instruction and a plurality of N-bit instructions (an integer respectively for L, M, N, and L M>N), wherein at least one N-bit instruction corresponds to an M-bit instruction. The processor includes an instruction inputting device, an instruction fetching device and an instruction mode converting device. The instruction inputting device has a memory space having a width of L-bit for storing a plurality of L-bit words representing instructions. The instruction fetching device fetches an L-bit word stored in the instruction inputting device, wherein the L-bit word fetched is one of the plurality of L-bit words. The instruction mode converting device converts an N-bit instruction into corresponding M-bit instruction when the L-bit word fetched by the instruction fetching device is an M-bit instruction and a previous L-bit word is an N-bit instruction. Alternately, if the N-bit instruction has not the corresponding M-bit instruction, at least one N-bit NOP instruction is inserted following the N-bit instruction.

According to another feature of the present invention, there is provided a method applying automatic mode conversion to align a word boundary in a multi-mode instruction processor, wherein instruction to be executed by the multi-mode instruction processor is come from an L-bit instruction boundary. The L-bit instruction word can contain an M-bit instruction and a plurality of N-bit instructions (an integer respectively for L, M, N, and L≧M>N), wherein at least one N-bit instruction corresponds to an M-bit instruction. The method includes the following steps: providing a plurality of L-bit words representing instructions; fetching one of the L-bit words, wherein when the one L-bit word fetched is an M-bit instruction and a previous L-bit word is an N-bit instruction, the N-bit instruction is converted into corresponding M-bit instruction if the N-bit instruction has the corresponding M-bit instruction, or on the contrary, at least one N-bit NOP instruction is inserted following the N-bit instruction; decoding the one L-bit word fetched to thus obtain a corresponding N-bit or M-bit instruction; and executing the corresponding N-bit or M-bit instruction.

Other objects, advantages, and novel features of the invention will become more apparent from the following detailed description when taken in conjunction with the accompanying drawings.

### BRIEF DESCRIPTION OF THE DRAWINGS

FIG. 1 is a conceptual chart of a typical instruction mode switching process;

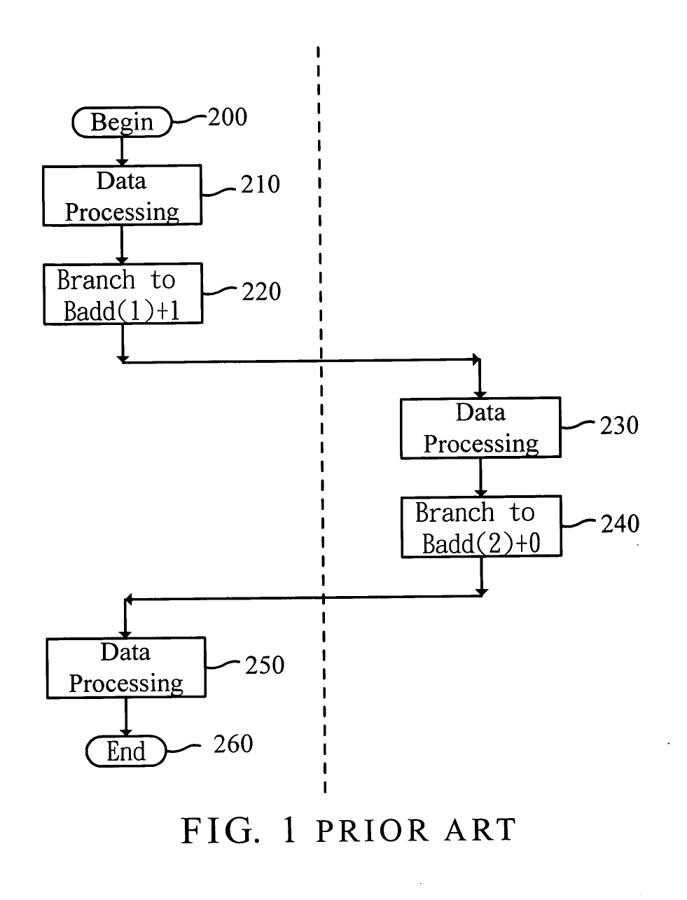

FIG. 2 is a schematic view of instruction formats of another typical instruction mode switching process;

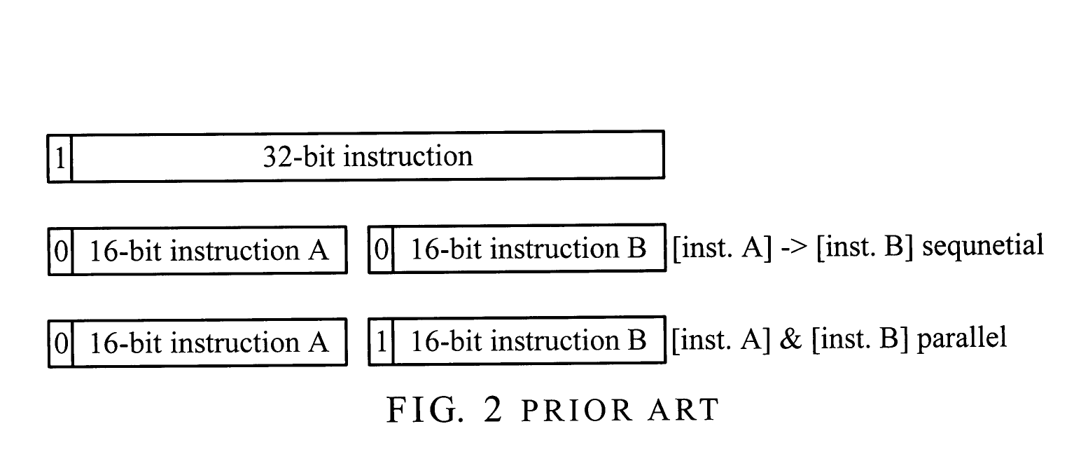

FIG. 3 shows an architecture of a processor capable of automatically converting instruction mode to align a word boundary of a multi-mode instruction in accordance with the invention;

FIG. 4 is a flowchart of a method capable of automatically converting instruction mode to align a word boundary of a multi-mode instruction in accordance with the invention;

FIG. 5 is an embodiment of FIG. 4 in accordance with the invention; and

FIG. 6 shows an example in accordance with the invention.

### DETAILED DESCRIPTION OF THE PREFERRED EMBODIMENT

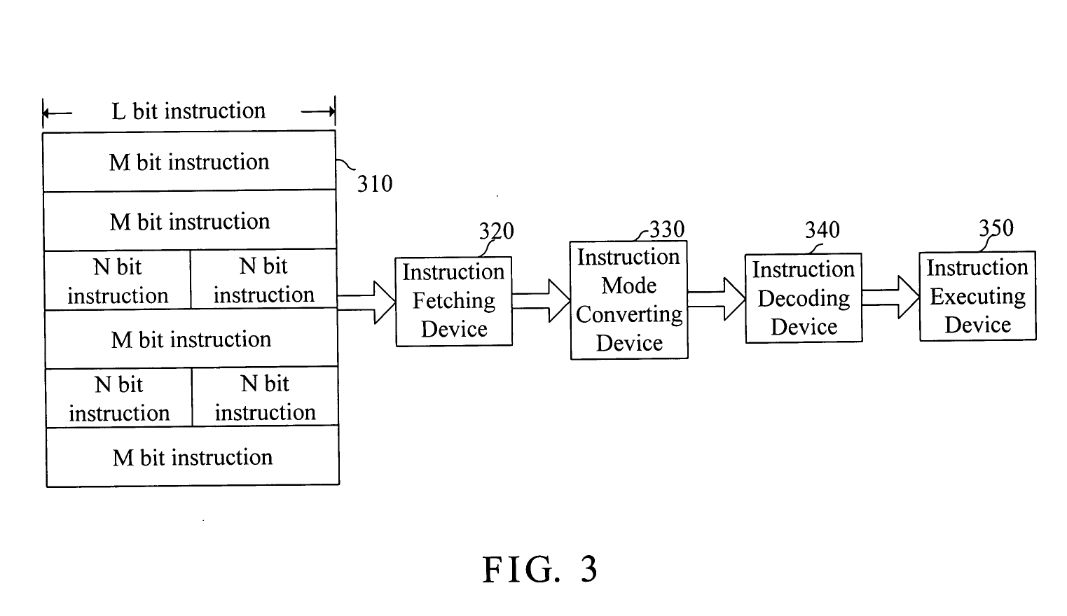

With reference to FIG. 3, there is shown an architecture of a processor capable of automatically converting instruction mode to align a word boundary of a multi-mode instruction in accordance with the invention. As shown, the processor includes an instruction input device 310, an instruction fetching device 320, an instruction mode converting device 330, an instruction decoding device 340 and an instruction executing device 350. The processor with multi-mode instructions has an M-bit instruction set and an N-bit instruction set (an integer respectively for M, N, and M>N). In the N-bit instruction set, at least one N-bit instruction is corresponding to an M-bit instruction in the M-bit instruction set. The instruction input device 310 provides a memory space having a width of L-bit instruction boundary (an integer for L, and L≧M) to store instructions to be executed. Word located in the L-bit instruction boundary can be an M-bit instruction or a plurality of N-bit instructions. In this embodiment, N, M and L are preferred to be 16, 32 and 32, respectively.

The instruction fetching device 320 fetches an L-bits (32-bits) word stored in the instruction input device 310. According to the content of the L-bit word fetched by the instruction fetching device 320, the instruction mode converting device 330 determines whether to convert the mode of the instruction or not. The instruction decoding device 340 is provided to decode the instruction outputted by the instruction mode converting device 330. The instruction executing device 350 executes the instruction decoded by the instruction decoding device 340.

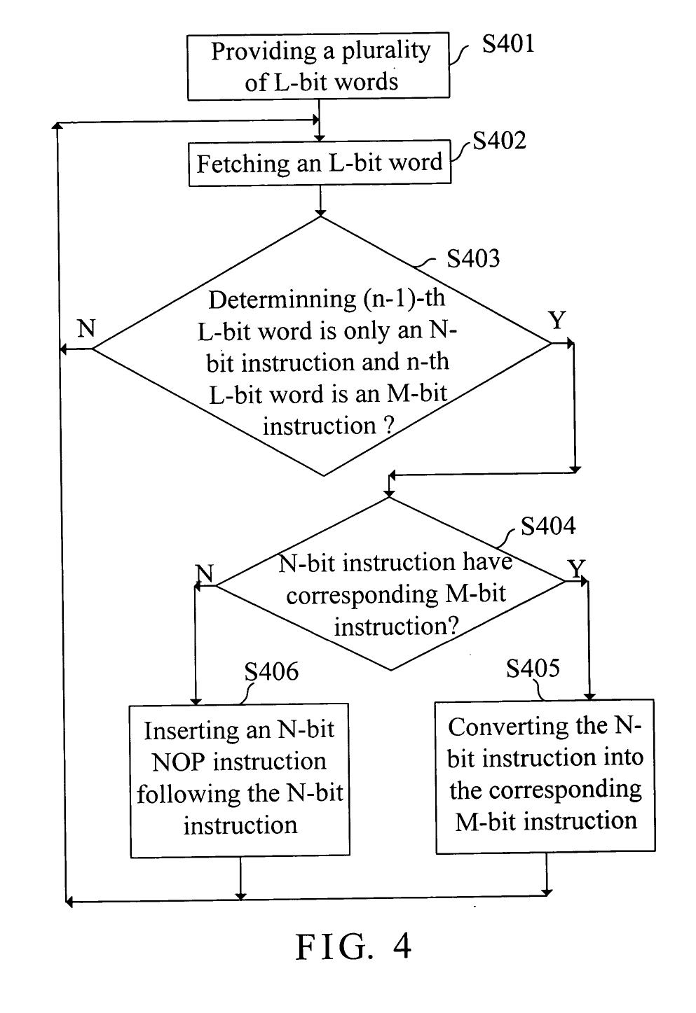

FIG. 4 shows a flowchart of the method for automatically converting instruction mode to align a word boundary of a multi-mode instruction in accordance with the invention. As shown, the instruction input device 310 first inputs a plurality of L-bit words representing instructions (step S401). In step S402, the instruction fetching device 320 fetches an L-bit word. In step S403, the instruction mode converting device 330 determines whether the fetched L-bit word (e.g., n-th L-bit word) is an M-bit instruction and its preceding L-bit word ((n−1)-th L-bit word) is an N-bit instruction. If not, no instruction conversion is performed; and if yes, it means that word may not be aligned due to the (n−1)-L-bit word, and thus an instruction conversion is required. Therefore, in step S404, it further determines whether the N-bit instruction represented by the (n−1)-th L-bit word has a corresponding M-bit instruction in the M-bit instruction set. If yes, the N-bit instruction represented by the (n−1)-th L-bit word is converted into the corresponding M-bit instruction (step S405), thus eliminating non-aligned word boundary. Then, an instruction fetch is performed (step 402).

On the contrary, if the N-bit instruction represented by the (n−1)-th L-bit word does not have a corresponding M-bit instruction in the M-bit instruction set, at least one N-bit NOP instruction following the N-bit instruction is inserted to fill up the L-bit instruction boundary (step S405), thereby eliminating non-aligned word boundary. In this embodiment, L=M=32 and N=16, and thus one N-bit (16-bit) NOP instruction is inserted.

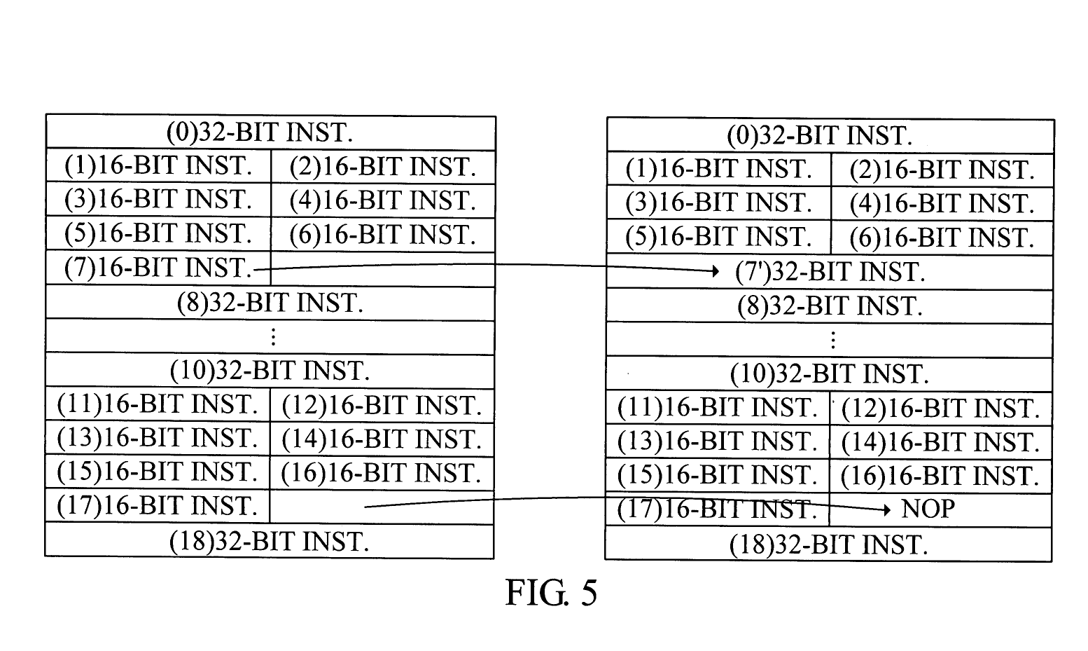

FIG. 5 shows a code segment for a program that is converted by the present invention. As shown, among the instructions to be executed, instruction (7) is a 16-bit instruction and instruction (8) is a 32-bit instruction, and thus non-aligned words are presented. As such, if the 16-bit instruction (7) has a corresponding 32-bit instruction (7′), the 16-bit instruction (7) is converted into the corresponding 32-bit instruction (7′) in accordance with the invention. In addition, in an example of instruction (17) being a 16-bit instruction and instruction (18) being a 32-bit instruction, because the 16-bit instruction (17) do not have a corresponding 32-bit instruction, a 16-bit NOP instruction is inserted following the 16-bit instruction (17) and before the instruction (18), so as to eliminate non-aligned words.

In view of the foregoing, it is known that, in the invention, the 16-bit instruction (7) is converted into the corresponding 32-bit instruction (7′), so that the processor can execute instruction (8) immediately following the 32-bit instruction (7′) without having to execute a 16-bit NOP instruction before instruction (8) is executed. Accordingly, this can increase the performance speed of the processor and overcome the prior problem in that the same memory block cannot store mixed 32-bit and 16-bit instructions.

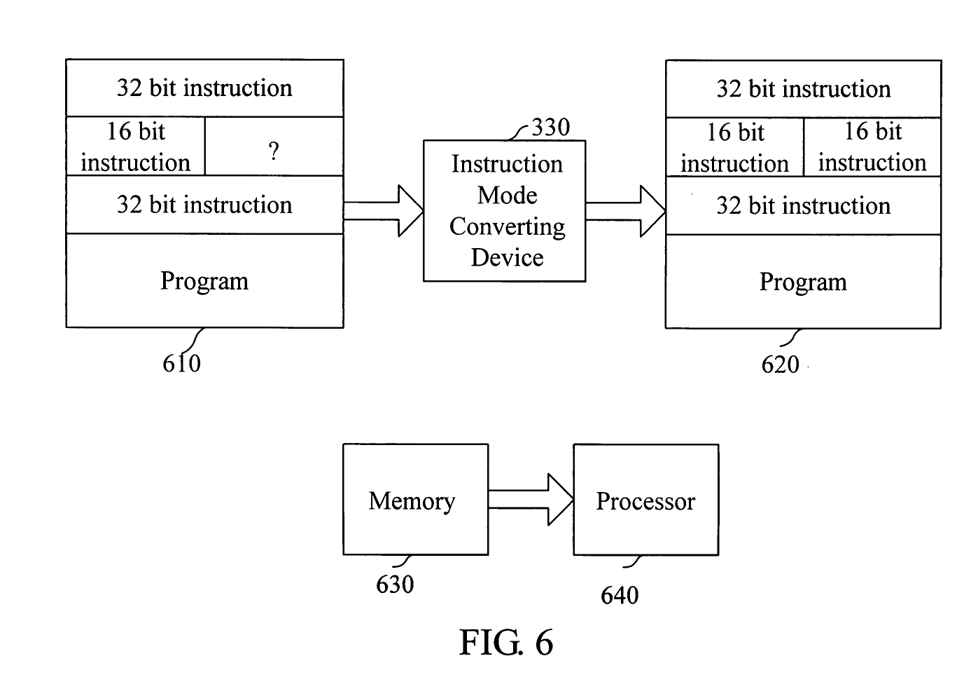

FIG. 6 shows another application in accordance with the invention. As shown, a program 610 with a plurality of 32-bit words has a plurality of 16-bit and 32-bit instructions. The program 610 can be converted by the inventive instruction mode converting device 330 into a program 620 when non-aligned words are presented in the program 610, as shown in FIG. 5 in which non-aligned words are encountered due to instructions (7) and (8). The program 620 is then stored in a memory 630. Such a conversion can be processed in offline with a software.

While a typical processor 640 runs the program 620 fetched from the memory 630, the hardware performance for word alignment is not necessary to the processor 640 since the program 620 is free of word alignment problem. This can reduce the design complexity of the processor 640 and also increase the execution performance.

Although the present invention has been explained in relation to its preferred embodiment, it is to be understood that many other possible modifications and variations can be made without departing from the spirit and scope of the invention as hereinafter claimed.

1. A processor capable of automatically converting instruction mode to align a word boundary of a multi-mode instruction, a multi-mode instruction to be executed being from an L-bit instruction word, the L-bit instruction word containing an M-bit instruction or a plurality of N-bit instructions (an integer respectively for L, M, N, and L≧M>N), and at least one N-bit instruction corresponding to an M-bit instruction, the processor comprising:
an instruction input device, which includes a memory having a width of L-bit for storing a plurality of L-bit words representing instructions;
an instruction fetching device, which fetches an L-bit word stored in the instruction input device; and
an instruction mode converting device, which converts an N-bit instruction into corresponding M-bit instruction if the N-bit instruction corresponds to the M-bit instruction or inserts at least one N-bit NOP instruction following the N-bit instruction if the N-bit instruction does not correspond to an M-bit instruction, when the L-bit word fetched by the instruction fetching device is an M-bit instruction and its preceding L-bit word is an N-bit instruction.

2. The processor as claimed in claim 1, further comprising:
an instruction decoding device, which decodes instructions outputted by the instruction mode converting device; and
an instruction executing device, which executes the instruction decoded by the instruction decoding device.

3. The processor as claimed in claim 1, wherein L=32, M=32, and N=16.

4. A method capable of automatically converting instruction mode to align a word boundary in a multi-mode instruction processor, an instruction to be executed by the multi-mode instruction processor being from an L-bit instruction word containing an M-bit instruction or a plurality of N-bit instructions (an integer respectively for L, M, N, and L≧M>N) and at least one N-bit instruction corresponding to an M-bit instruction, the method comprising:
providing a plurality of L-bit words representing instructions;
fetching one of the L-bit words, wherein, when the fetched L-bit word is an M-bit instruction and its preceding L-bit word is an N-bit instruction, the N-bit instruction is converted into corresponding M-bit instruction if the N-bit instruction corresponds to the M-bit instruction or at least one N-bit NOP instruction is inserted following the N-bit instruction if the N-bit instruction does not correspond to an M-bit instruction;
decoding the fetched L-bit word to thus obtain a corresponding N-bit or M-bit instruction; and
executing the decoded N-bit or M-bit instruction.

5. The method as claimed in claim 4, wherein L=32, M=32, and N=16.

6. A method for converting program instruction to align a word boundary, the program instruction having an L-bit instruction boundary, the L-bit instruction word containing an M-bit instruction or a plurality of N-bit instructions (an integer for L, M, N, and L≧M>N), at least one N-bit instruction corresponding to an M-bit instruction, the method comprising:
fetching an L-bit word which is an M-bit instruction and its preceding L-bit word is an N-bit instruction; and
if the N-bit instruction corresponds to an M-bit instruction, converting the N-bit instruction into the corresponding M-bit instruction; and
if the N-bit instruction does not correspond to an M-bit instruction, inserting at least one N-bit NOP instruction following the N-bit instruction.

7. The method as claimed in claim 6, wherein L=32, M=32, and N=16.
